(19) United States
(12) Patent Application Publication
(10) Pub. No.: US 2017/0109203 A1
(43) Pub. Date: Apr. 20, 2017

(54) TASK SCHEDULING

(71) Applicant: International Business Machines Corporation, Armonk, NY (US)

(72) Inventors: Guan Jun Liu, Beijing (CN); Niao Qing Liu, Beijing (CN); Ai Lian Mi, Beijing (CN); Bei Chun Zhou, Beijing (CN)

(21) Appl. No.: 14/883,678

(22) Filed: Oct. 15, 2015

(51) Int. Cl. G06F 9/50

(52) U.S. Cl. CPC G06F 9/50

(57) ABSTRACT

Embodiments of the present invention may schedule a task in a processing system. According to one embodiment of the present invention, a resource to be accessed by a task in a processing system is determined based on a type of a request for initiating the task. Then, a length of a task queue that records at least one task waiting for the resource is determined Next, the request is suspended in response to the length of the task queue being greater than a predefined threshold.

### BACKGROUND

With developments of computer technologies, processing systems such as transaction processing (TP) systems have already been involved in various respects in people's daily work and life. These processing systems have become key aspects to support mission critical businesses around the world. For example, TP systems are widely used in institutions like banks to provide automated transaction processing. The TP system used by a bank processes a variety of transactions, such as customer-requested deposit, withdrawal, transfer and so on.

So far the TP system can concurrently process tens of thousands of and even more transactions. For example, the TP system of the bank can serve a plurality of countries and regions and can simultaneously respond to requests from users in various locations. Usually, the TP system includes a number of processing components such as a transaction manager, a queue manager, a resource manager and the like. When a great number of requests are received within a short time, resource shortages and conflicts such as resource interlocks occur among the processing components in the TP system. As a result, performance of the TP system will be degraded.

### SUMMARY

In one aspect of the present invention, a computer-implemented method is proposed. According to the method, a resource to be accessed by a task in a processing system is determined based on a type of a request for initiating the task. Then, a length of a task queue that records at least one task waiting for the resource is determined Next, the request is suspended in response to the length of the task queue being greater than a predefined threshold.

In another aspect of the present invention, a computing system is proposed. The computing system comprises a computer processor coupled to a computer-readable memory unit, the memory unit comprises instructions that when executed by the computer processor implements a method. In the method, a resource to be accessed by a task in a processing system is determined based on a type of a request for initiating the task. Then, a length of a task queue that records at least one task waiting for the resource is determined Next, the request is suspended in response to the length of the task queue being greater than a predefined threshold.

In yet another aspect of the present invention, a computer program product is proposed. The computer program product is tangibly stored on a non-transient machine readable medium and comprises executable instructions which, when executed on an electronic device, cause the electronic device to: determine a resource to be accessed by a task in a processing system based on a type of a request for initiating the task; determine a length of a task queue that records at least one task waiting for the resource; and suspend the request in response to the length of the task queue being greater than a predefined threshold.

It is to be understood that the Summary is not intended to identify key or essential features of embodiments of the present invention, nor is it intended to be used to limit the scope of the present invention. Other features of the present invention will become easily comprehensible through the description below.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 schematically illustrates an example computer system/server 12 which is applicable to implement embodiments of the present invention;

FIG. 2 schematically illustrates an example procedure for processing a request in a TP system;

FIG. 3 schematically illustrates a block diagram for scheduling a task in a TP system according to one embodiment of the present invention;

FIG. 4 schematically illustrates a flowchart of a method for scheduling a task in a TP system according to one embodiment of the present invention;

FIG. 5 schematically illustrates a detailed block diagram for scheduling a task in a TP system according to one embodiment of the present invention;

FIG. 6 schematically illustrates a block diagram of a resource manager that manages resources in a TP system according to one embodiment of the present invention;

FIG. 7 schematically illustrates a block diagram of messages communicated between a task manager and a resource manager in a TP system according to one embodiment of the present invention; and

FIG. 8 schematically illustrates a block diagram for processing a suspended request in the request queue according to one embodiment of the present invention.

Throughout the drawings, same or similar reference numerals represent the same or similar elements.

### DETAILED DESCRIPTION

Principle of the present invention will now be described with reference to some example embodiments. It is to be understood that these embodiments are described only for the purpose of illustration and help those skilled in the art to understand and implement the present invention, without suggesting any limitations as to the scope of the invention. The invention described herein can be implemented in various manners other than the ones describe below.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

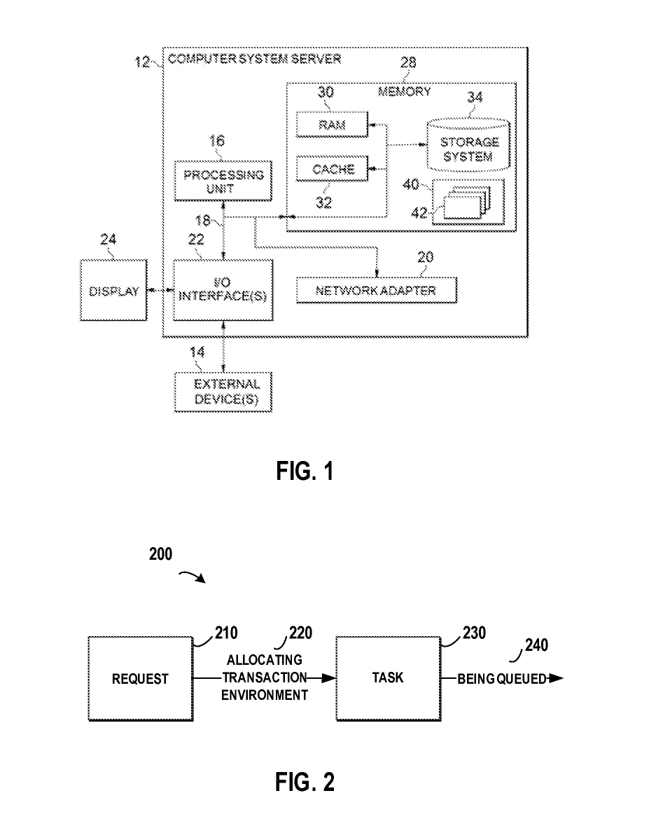

Reference is first made to FIG. 1, in which an example electronic device or computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a memory 28, and a bus 18 that couples various system components including memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

Memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, and the like. One or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

It would be appreciated that the computer system/server 12 illustrated in FIG. 1 is only an example for implementing one embodiment of the present invention. In another embodiment of the present invention, other computing devices may be adopted, for example, if the present invention is implemented in a cloud computing environment, the risk evaluation may be implemented in a computing node in the cloud computing environment.

In the context of the present invention, descriptions will be made by taking a banking system as an example processing system. However, the methods, systems and computer program products according to the present invention may be applied to another processing system comprising but not being limited to a trading system, a finance system and the like.

According to some approaches, once a request is received in the TP system, the request is allocated with a required initialization environment and thus a task is initiated by the request. However, when the initialization environment is allocated, the state of a certain resource to be accessed by the task is unknown. For example, the resource might be free, or it might be occupied by another task. In the latter case, the initiated task has to wait until the other task releases the resource. Meanwhile, the initialization environment allocated to the task is idly wasted and cannot be allocated to other tasks. For clarity, meanings of some terms used in the context of the present invention are explained as below.

In the context of the present invention, a request refers to an instruction for initiating a task from a user of the TP system. For example, in a banking system, if a customer withdraws 20 dollars from his bank account via an automatic teller machine, the withdrawal instruction received in the banking system is called a request.

A task refers to a transaction that is initiated by a request and then implemented in the TP system. Continuing the above example, the task initiated by the withdrawal instruction relates to checking the validity of the customer's account in a file storing the customer information, checking the balance of the account in a file storing the customer's detailed data and other processing. Although in embodiments of the present invention described below, deposit transaction, withdrawal transaction and transfer transaction are taken as examples of the task, the task may comprise other types of transactions. For example, in a trading system, the task may comprise a biding transaction, a buying transaction and the like.

A resource refers to an object that is to be accessed by the task. For example, in the above example, the file storing the customer information and the file storing the customer's detailed data are example resources. It would be appreciated that although the above two files are taken as example resources, in other embodiments of the present invention, the resource may be any type of object that is needed by the task. For example, an index of the file may be considered as a resource. Further, when a database is used for storing data in the TP system, the database, a table included in the database, a column in the table or even a data entry may be considered as resources.

An initialization environment refers to a certain amount of resources associated with the request for initiating a task. It would be appreciated that although embodiments of the present invention are described below by taking a transaction environment as an example initialization environment in the TP system, the initialization environments may relate to other resources in other types of processing systems.

FIG. 2 schematically illustrates an example procedure 200 for processing a request in a TP system. In this figure, request 210 is a request for initiating a task in the TP system. Then, the TP system allocates (220) a corresponding transaction environment to the request 210. The transaction environment includes, for example, one or more memory blocks for recording the runtime data of the task and the CPU capacity for enabling the task. The content of the transaction environment is associated with the type of the request. After being allocated with the required transaction environment, the request 210 initiates a task 230. Next, the task 230 accesses the resource required for implementing the task 230. However, as shown by arrow 240, if the required resource is occupied by another task, the task 230 is queued in a task queue waiting for the release of the required resource.

A number of tasks (for example, 90 tasks) may be applying for accessing a certain Resource A, however, the Resource A is available for being accessed by only one task (for example, the Resource A is locked by another task), then only the first task may access the Resource A and the other 89 tasks are queued waiting for the release of the Resource A. In this example, if each task costs 100 MB of the memory and 1% of the CPU capacity in the TP system, then the transaction environments (8900 MB of the memory and 89% of the CPU capacity) allocated to the 89 queued tasks are idly wasted and cannot be utilized by other tasks.

As the total amount of memory and CPU capacity in the TP system are limited by the physical capacity of the TP system, when each of a great number of requests is allocated with the required transaction environment, resource shortage and interlocks may be caused in the TP system. In the above example, when 89% of the CPU capacity is occupied, the TP system is very close to a system crash.

In view of the above, the present invention proposes a method for scheduling a task. According to one embodiment of the present invention, a computer-implemented method is proposed. According to the method, in a TP system, a resource to be accessed by a task in a processing system is determined based on a type of a request for initiating the task. Then, a length of a task queue that records at least one task waiting for the resource is determined. Next, the request is suspended in response to the length of the task queue being greater than a predefined threshold.

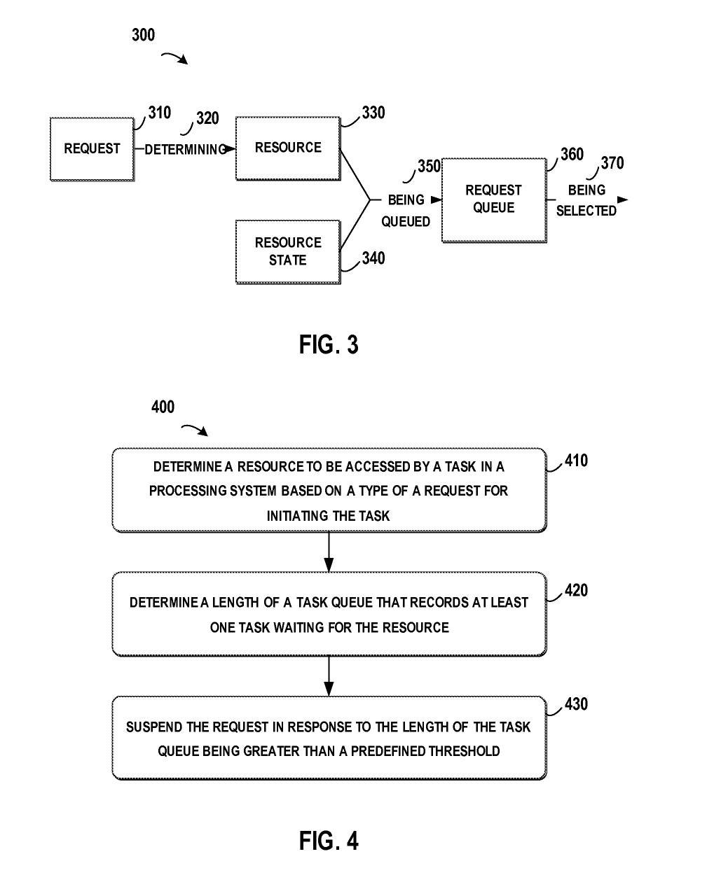

FIG. 3 schematically illustrates a block diagram 300 for scheduling a task in a TP system according to one embodiment of the present invention. In FIG. 3, a request 310 is received in the TP system and then a type of the request 310 is obtained so as to determine (320) a resource 330 to be accessed by a task to be initiated by the request 310. Further, a resource state 340 of the resource 330 is received to determine whether the resource 330 may be allocated to the request 310 at this time.

With respect to the resource 330, if the resource is occupied and locked by another task, then the request 310 has to wait for the resource. Meanwhile, if other tasks are also waiting for the resource, then the request 310 is queued (350) in a request queue 360 which includes the other request(s) waiting for the resource. Further, if the resource state 340 changes (for example, if the resource is released), then a request is selected (370) from the request queue 360 for further processing (for example, the processing as illustrated in FIG. 2).

According to the approach illustrated in FIG. 3, before the task is initiated from the request 310, the state of the resource that is to be accessed by the task associated with the request 310 is checked, to determine whether the required resource may be allocated to the task within a short period after the task is initiated. If the resource may be allocated immediately (for example, the resource is free) or after a while (for example, a small number of tasks are waiting for the resource), then a transaction environment may be allocated to the request 310 and then a task is initiated by the request 310. Otherwise, if the resource will not be available for a long time in the future (for example, a great number of tasks are waiting for the resource), then the request 310 is suspended instead of being allocated with the transaction environment necessary for initiating a task.

In FIG. 3, although only one resource 330 is illustrated in the example, in another example, the request 310 may access more resources. Similarly, the processing step to each of other resources is identical to what is illustrated in FIG. 3. With the above embodiment of the present invention, the request is suspended in a circumstance that the resource required by the task associated with the request will not be available in a certain period. At this point, the transaction environment required by the request is saved for other requests. Continuing the above example, if the Resource A is required by the 90 requests and it can be allocated to only one task, then the first request initiates a task and then the Resource A is allocated to the task. Further, the other 89 requests are suspended waiting for the task releasing the Resource A. At this point, the transaction environments (8900 M memory and 89% of the CPU capacity) required by the 89 queued requests are saved and available for other requests.

Details of the method will be described with reference to FIG. 4, which schematically illustrates a flowchart 400 of a method for scheduling a task in a TP system according to one embodiment of the present invention. In Step 410, a resource to be accessed by a task in a processing system is determined based on a type of a request for initiating the task.

The type of the task depends on the type of the request. A deposit request initiates a deposit task, a withdrawal request initiates a withdrawal task, and so on. In this embodiment, the resources to be accessed by various tasks may be determined in advance. A resource access history may be stored in a resource access history table as illustrated in Table 1.

TABLE 1
Resource Access History Table

| ID | Type of Task | Resource |
|---|---|---|
| 1 | Deposit | Resource A, Resource B, Resource C |
| 2 | Withdrawal | Resource A, Resource B, Resource D |
| 3 | Transfer | Resource B, Resource D, Resource E |
| . . . | . . . | . . . |

It would be appreciated that Table 1 is only an example data structure for storing the resource access history, any other data structure may be adopted according to the specific environment of the present invention. In this step, the table may be searched to determine the resource to be accessed by a certain type of task. From Table 1, it is determined that the resources to be accessed by a task associated with a deposit request relate to the Resource A, Resource B and Resource C, and that the resources to be accessed by a task associated with a withdrawal request relate to the Resource A, Resource B and Resource D. Alternatively and/or additionally, the resources to be accessed by the task associated with the request may be determined after the request is received.

In Step 420, a length of a task queue that records at least one task waiting for the resource is determined As waiting time depends on how many tasks included in the task queue are waiting for the resource, the length of the task queue is an indicator for the waiting time. In this step, the length may be considered as a base for determining whether to suspend the request or not.

In Step 430, the request is suspended in response to the length of the task queue being greater than a predefined threshold. In this step, the suspended request refers to a request that is waiting for being allocated with an initialization environment. The threshold is a predefined value for determining a further processing step for the request. For example, the threshold may be set to a value of “5” by the administrator of the TP system. At this point, if there are 6 tasks in the task queue waiting for the Resource A, then the request is suspended. Otherwise, for example, if there are only 2 tasks waiting for the Resource A, then the request is not suspended. In another embodiment, the threshold may be set to another value more or less than “5.”

With the method of the present invention, once a certain resource is in shortage in the TP system, an incoming request applying for the certain resource is suspended and no transaction environment is allocated to the incoming request. At this point, the transaction environment is available for other requests applying for other resources. Further, if the resource is not occupied any more, then the incoming request is allocated with the transaction environment and thus further processing is performed to the incoming request.

In one embodiment of the present invention, in response to the length of the task queue being equal to or less than the predefined threshold, an initialization environment may be allocated to the request to initiate the task. Next, the initiated task may be added into the task queue.

The length of the task queue being equal to or less than the predefined threshold indicates that the resource to be accessed by the task associated with the request will be available immediately. Accordingly, the request may be allocated with the required transaction environment and the task is initiated from the request. At this point, the task is ready for the further processing. In this embodiment, the length of the task queue may vary during the operation of the TP system. For example, the length may be increased when a new task is added into the task queue, while the length may be decreased when a task in the task queue is allocated with the required resource. Once the length satisfies a predefined rule, then the request may be allocated with the required transaction environment. Embodiments of the predefined rule will be described below.

In one embodiment of the present invention, the request may be added into a request queue, where the request queue records at least one suspended request waiting for allocation of corresponding initialization environment. In this embodiment, if there are multiple requests applying for a same resource being in shortage, then the multiple requests may be queued in a request queue waiting for the resource becoming available.

It would be appreciated that although the above description illustrates examples where only one resource is in shortage, more resources to be accessed by one or more tasks associated with one or more requests may be in shortage. For example, there are one deposit request applying for Resources A, B and C, and one withdrawal request applying for Resources A, B and D. If the Resource A is in shortage, then depending on a time order for receiving the two requests, the deposit request and the withdrawal request are queued in the request queue waiting for the Resource A. In another example, there are three requests, a deposit request, a withdrawal request and a transfer request, and the Resources A and E are in shortage. According to Table 1, the deposit request and the withdrawal request may be queued in the queue waiting for the Resource A, and the transfer request may be queued in the queue waiting for the Resource E.

In one embodiment of the present invention, a request may be selected from the request queue in response to the length of the task queue being equal to or less than the predefined threshold. Then, the selected request may be allocated with a transaction environment to initiate a further task, further the further task may be initiated and then added into the task queue.

In embodiments of the present invention, the length of the task queue may be dynamically received at runtime of the TP system. For example, the existing communication package within the TP system may be extended to contain information of the length of the task queue. Alternatively, a new message may be created for carrying the length. Once the updated length becomes equal to or less than the predefined threshold, one request may be selected from the request queue. Then, the selected request may be allocated with the transaction environment and thus further processing is performed to the selected request.

In this embodiment, all of the requests in the request queue are suspended, namely, they are not allocated with corresponding transaction environments. Even if there are thousands of requests in the queue, they do not occupy much memory space and/or CPU capacity in the TP system because they are not initiated tasks. In contrast, if the thousands of requests were allocated with corresponding transaction environments, as it might be the case according to conventional approaches, considerable memory space and/or CPU capacity would be occupied in the TP system.

In one embodiment of the present invention, the request may be selected from the request queue according to a priority of the request. In the TP system, different requests may have different priorities. For example, in the above banking system, compared with the deposit request, the withdrawal request may be set to a high priority. Accordingly, the request with a high priority may be selected first from the request queue. A selecting rule may be predefined in the TP system. For example, one rule may define that the requests with low priorities should wait until the requests with high priorities have been proceed. Alternatively, another rule may define that the requests with low priorities and high priorities should be processed alternately. Further, if two requests in the queue have the same priority (for example, both of them are withdrawal requests), then a request that is early queued should be processed first.

In one embodiment of the present invention, an implementation history of a task initiated by a historical request may be tracked, where a type of the historical request is identical to the type of the request. Then, the resource may be determined from the implement history.

The implementation history of various types of tasks may be tracked in the TP system. The components in the TP system may record the resources that have been accessed by a certain type of request. For example, during processing a previous deposit request, the TP system may record that Resources A, B and C are accessed. Accordingly, it may be determined that a deposit request accesses Resources A, B and C. The resources may be recorded in a resource access history as illustrated in Table 1. With Table 1, the resource to be accessed by a task associated with an incoming request may be determined easily.

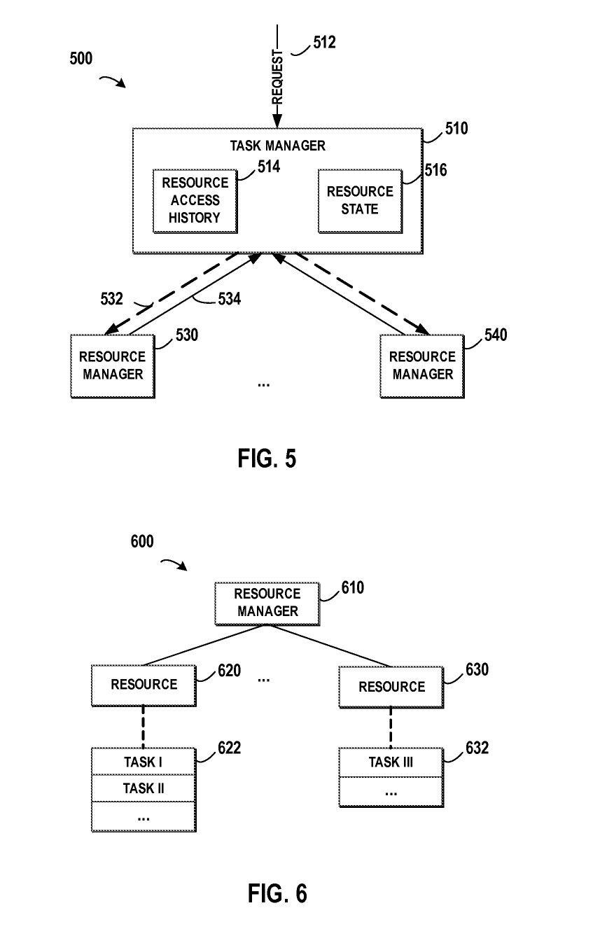

In one embodiment of the present invention, a message associated with a further task may be obtained from a resource manager managing the resource. Then the length of the task queue may be extracted from the message. In this embodiment, communication packets within the TP system may be utilized to carry the length of the task queue waiting for the resource. Reference will be made to FIG. 5, which schematically illustrates a detailed block diagram 500 for scheduling a task in a TP system according to one embodiment of the present invention.

In FIG. 5, a task manager 510 receives a request 512, determines the resource(s) to be accessed by a task associated with the request 512 from a resource access history 514, and receives the length of the task queue waiting for the resource(s) from the resource state 516. Although the resource access history 514 and the resource state 516 are illustrated within the task manager 510, in another embodiment, the resource access history 514 and the resource state 516 may be located at another location, as long as the task manager 510 may access the resource access history 514 and the resource state 516.

In the TP system, the task manager 510 communicates with multiple resource managers such as a resource manager 530, . . . , and a resource manager 540. The communication packets following predefined rules specified in the TP system are transmitted to and from the task manager 510 and the resource manager 530 and 540. For example, a message 532 is sent from the task manager 510 to the resource manager 530, another message 534 is sent from the resource manager 530 to the task manager 510.

In one embodiment of the present invention, the message may be encoded with a length of a further task queue, where the further task queue records a task waiting for a further resource managed by the resource manager. For example, a withdrawal task is a task managed by the task manager 510, and the withdrawal task needs to access the Resource A managed by the resource manager 530. In processing the withdrawal task, multiple messages about the withdrawal task are transmitted to and from the task manager 510 and the resource manager 530.

As illustrated in FIG. 5, an arrow with the dash line indicates a message 532 from the task manager 510 and an arrow with the solid line indicates a message 534 to the task manager 510. The state of all or a portion of the resources managed by the resource manager 530 may be collected and encoded into the communication packets for transmitting messages for other tasks. At this point, the message 534 may be utilized for carrying the length of task queues for the multiple resources managed by the resource manager 530. For example, if the resource manager 530 manages multiple resources such as Resources A to Z, then the message 534 may carry information on the length of task queues for Resources A to Z.

FIG. 6 schematically illustrates a block diagram 600 of a resource manager that manages resources in a TP system according to one embodiment of the present invention. A resource manager 610 manages multiple resources such as resource 620, . . . , and resource 630. A task queue 622 for the resource 620 and a task queue 632 for the resource 630 are illustrated in this figure. In this example, the task queue 622 includes Task I, Task II, and possibly other tasks, and the task queue 632 includes Task III and possibly other tasks. In the embodiments of the present invention, the lengths of the task queue 622 and the task queue 632 may be encoded into the message 534 as illustrated in FIG. 5.

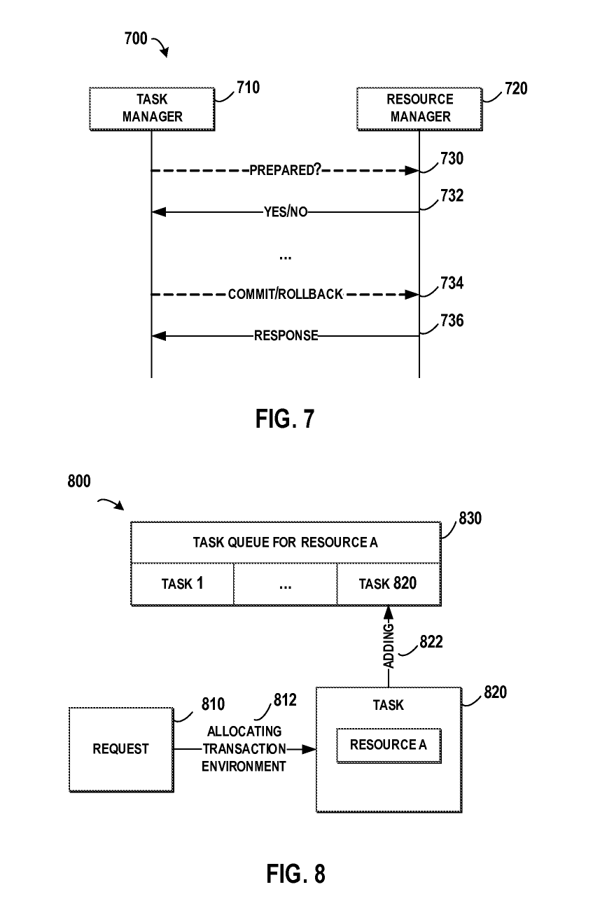

Descriptions about how to transmit the length via the message from the resource manager to the task manager will be provided with reference to FIG. 7, which schematically illustrates a block diagram 700 of messages between a task manager and a resource manager in a TP system according to one embodiment of the present invention. Multiple messages are communicated between a task manager 710 and a resource manager 720 during operations of the TP system.

For example, a message 730 may be sent from the task manager 710 to the resource manager 720 to inquire whether the resource manager 720 is ready for further procedure. Then the resource manager 720 sends back to the task manager 710 a “YES” or “NO” message 732 indicating that whether it is ready or not. At this point, the length of the task queue waiting for a resource managed by the resource manager 720 may be encoded into the message 732. For another example, a message 734 may be sent from the task manager 710 to the resource manager 720 to instruct the resource manager 720 to implement a “COMMIT” instruction or a “ROLLBACK” instruction. Then the resource manager 720 sends back to the task manager 710 a “RESPONSE” message 736 indicating whether the received instruction is implemented successfully or not. At this point, the length of the task queue waiting for a resource managed by the resource manager 720 may be encoded into the response message 736.

It would be appreciated that FIG. 7 only illustrates some example types of messages that may be utilized in carrying the lengths, in another embodiment, other type of messages sent from the resource manager 720 to the task manager 710 may be encoded with the length.

As a great number of messages may be transmitted from the resource manager 530 to the task manager 710 in the TP system, the resource state in task manager 710 may be updated in real time. In this embodiment, the length of the task queue may be represented by several bits, and the workload for transmitting the lengths of even tens of task queues will have slight influence to the traffic and thereby may be neglected.

Moreover, an optimized method may be adopted for further reducing the traffic being transmitted to the task manager 710. For example, the length of the task queue may be transmitted to the task manager 710 only if the length is greater than the predefined threshold. At this point, only the length greater than the threshold is encoded in the message, and thus the irrelevant lengths are filtered out by the threshold. Further, the length may be transmitted to the task manager 710 only when the length is changed.

In one embodiment of the present invention, the predefined threshold may be modified according to workloads of the TP system. For example, if there are plenty of memory and CPU capacity in the TP system, the threshold may be set to a higher value, because allocating to more requests corresponding transaction environments will not result in a shortage of the memory and CPU capacity in the TP system. Alternatively, if the memory and CPU capacity are not sufficient right now, then setting the threshold to a low value will prevent further transaction environment from being allocated to a queued request.

As the length of the task queue waiting for a resource is updated dynamically, when the tasks waiting for the resource falls within the threshold, the request suspended in the request queue may be selected for further processing. FIG. 8 schematically illustrates a block diagram 800 for processing a suspended request in the request queue according to one embodiment of the present invention. In this figure, a request 810 is selected from the request queue, and then it may be allocated (812) with a corresponding transaction environment. At this point, a task 820 is initiated from the request 810. The task 820 is then added (822) into the task queue waiting for each of the resources to be accessed. In this example, because the task 820 will access the Resource A and possibly other resources, the task 820 is added into the task queue 830 waiting for the Resource A.

According to embodiments of the present invention, if a certain resource is in shortage in the TP system, an incoming request applying for the resource is suspended and no initialization environment is allocated to the incoming request. Under this condition, the initialization environment is available for other requests applying for other resources. During the operation of the TP system, if the resource is not in shortage any more, then the incoming request is allocated with the initialization environment and thus further processing is performed for the incoming request.

Various embodiments implementing the method of the present invention have been described above with reference to the accompanying drawings. Those skilled in the art may understand that the method may be implemented in software, hardware or a combination of software and hardware. Moreover, those skilled in the art may understand by implementing steps in the above method in software, hardware or a combination of software and hardware, there may be provided an apparatus/system based on the same invention concept. Even if the apparatus/system has the same hardware structure as a general-purpose processing device, the functionality of software contained therein makes the apparatus/system manifest distinguishing properties from the general-purpose processing device, thereby forming an apparatus/system of the various embodiments of the present invention. The apparatus/system described in the present invention comprises several means or modules, the means or modules configured to execute corresponding steps. Upon reading this specification, those skilled in the art may understand how to write a program for implementing actions performed by these means or modules. Since the apparatus/system is based on the same invention concept as the method, the same or corresponding implementation details are also applicable to means or modules corresponding to the method. As detailed and complete description has been presented above, the apparatus/system is not detailed below.

According to one embodiment of the present invention, a computing system is proposed. The computing system comprises a computer processor coupled to a computer-readable memory unit, the memory unit comprising instructions that when executed by the computer processor implements a method. In the method, a resource to be accessed by a task in a processing system is determined based on a type of a request for initiating the task. Then, a length of a task queue that records at least one task waiting for the resource is determined. Next, the request is suspended in response to the length of the task queue being greater than a predefined threshold.

In one embodiment of the present invention, in response to the length of the task queue being equal to or less than the predefined threshold, an initialization environment may be allocated to the request to initiate the task, and then the task may be added into the task queue in response to the task being initiated.

In one embodiment of the present invention, the request may be added into a request queue, where the request queue records at least one suspended request waiting for being allocated with an initialization environment.

In one embodiment of the present invention, a request may be selected from the request queue in response to the length of the task queue being equal to or less than the predefined threshold. Then, an initialization environment may be allocated to the selected request to initiate a further task. Next, the further task may be added into the task queue in response to the task being initiated.

In one embodiment of the present invention, the request may be selected from the request queue according to a priority of the request.

In one embodiment of the present invention, an implementation history of a task initiated by a historical request may be tracked, where a type of the historical request is identical to the type of the request. Then, the at least one resource may be determined from the implement history.

In one embodiment of the present invention, a message associated with a further task may be obtained from a resource manager managing the resource. Then, the length of the task queue may be extracted from the message.

In one embodiment of the present invention, the message is encoded with a length of a further task queue, where the further task queue records a task waiting for a further resource managed by the resource manager.

In one embodiment of the present invention, the predefined threshold may be modified according to workloads of the processing system.

According to one embodiment of the present invention, a computer program product is proposed. The computer program product is tangibly stored on a non-transient machine-readable medium and comprising machine-executable instructions. The instructions, when executed on an electronic device, cause the electronic device to: determine a resource to be accessed by a task in a processing system based on a type of a request for initiating the task; determine a length of a task queue that records at least one task waiting for the resource; and suspend the request in response to the length of the task queue being greater than a predefined threshold.

In one embodiment of the present invention, the instructions further cause the electronic device to: in response to the length of the task queue being equal to or less than the predefined threshold, allocate to the request an initialization environment to initiate the task; and add the task into the task queue in response to the task being initiated.

In one embodiment of the present invention, the instructions further cause the electronic device to: add the request into a request queue, where the request queue records at least one suspended request waiting for being allocated with an initialization environment.

In one embodiment of the present invention, the instructions further cause the electronic device to: select a request from the request queue in response to the length of the task queue being equal to or less than the predefined threshold; and allocate to the selected request an initialization environment to initiate a further task; and add the further task into the task queue in response to the task being initiated.

In one embodiment of the present invention, the instructions further cause the electronic device to: select the request from the request queue according to a priority of the request.

In one embodiment of the present invention, the instructions further cause the electronic device to: track an implementation history of a task initiated by a historical request, a type of the historical request being identical to the type of the request; and determine the at least one resource from the implement history.

In one embodiment of the present invention, the instructions further cause the electronic device to: obtain from a resource manager managing the resource a message associated with a further task; and extract the length of the task queue from the message.

In one embodiment of the present invention, the message may be encoded with a length of a further task queue, where the further task queue records a task waiting for a further resource managed by the resource manager.

In one embodiment of the present invention, the instructions further cause the electronic device to: modify the predefined threshold according to workloads of the processing system.

Moreover, the system may be implemented by various manners, including software, hardware, firmware or a random combination thereof. For example, in some embodiments, the apparatus may be implemented by software and/or firmware. Alternatively or additionally, the system may be implemented partially or completely based on hardware. for example, one or more units in the system may be implemented as an integrated circuit (IC) chip, an application-specific integrated circuit (ASIC), a system on chip (SOC), a field programmable gate array (FPGA), etc. The scope of the present intention is not limited to this aspect.

The present invention may be a system, an apparatus, a device, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present invention. In this regard, each block in the flowchart or block diagrams may represent a module, snippet, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
determining a resource to be accessed by a task in a processing system based on a type of a request for initiating the task, the processing system including a computer system and determining the type of request;
determining, by the computer system, a length of a task queue that records at least one task waiting for the resource; and
suspending, by the computer system, the request in response to the length of the task queue being greater than a predefined threshold.

2. The method of claim 1, further comprising:
in response to the length of the task queue being equal to or less than the predefined threshold;
allocating to the request an initialization environment to initiate the task; and
adding the task into the task queue in response to the task being initiated.

3. The method of claim 1, wherein the suspending the request comprises:
adding the request into a request queue, the request queue recording at least one suspended request waiting for being allocated with an initialization environment.

4. The method of claim 3, further comprising:
selecting a request from the request queue in response to the length of the task queue being equal to or less than the predefined threshold; and
allocating to the selected request an initialization environment to initiate a further task; and
adding the further task into the task queue in response to the further task being initiated.

5. The method of claim 4, wherein selecting the request from the request queue further comprises:
selecting the request from the request queue according to a priority of the request.

6. The method of claim 1, wherein determining the resource to be accessed by the task comprises:
tracking an implementation history of a task initiated by a historical request, a type of the historical request being identical to the type of the request; and
determining the resource from the implement history.

7. The method of claim 1, wherein determining the length of the task queue comprises:
obtaining from a resource manager managing the resource a message associated with a further task; and
extracting the length of the task queue from the message.

8. The method of claim 7, wherein the message is encoded with a length of a further task queue, the further task queue recording a task waiting for a further resource managed by the resource manager.

9. The method of claim 1, further comprising:
modifying the predefined threshold according to workloads of the processing system.

10. A computing system comprising a computer processor coupled to a computer-readable memory unit, the memory unit comprising instructions that when executed by the computer processor implements a method comprising:
determining a resource to be accessed by a task in a processing system based on a type of a request for initiating the task;
determining a length of a task queue that records at least one task waiting for the resource; and
suspending the request in response to the length of the task queue being greater than a predefined threshold.

11. The system of claim 10, wherein the method further comprise:
in response to the length of the task queue being equal to or less than the predefined threshold;
allocating to the request an initialization environment to initiate the task; and
adding the task into the task queue in response to the task being initiated.

12. The system of claim 10, wherein suspending the request comprises:
adding the request into a request queue, the request queue recording at least one suspended request waiting for being allocated with an initialization environment.

13. The system of claim 12, wherein the method further comprise:
selecting a request from the request queue in response to the length of the task queue being equal to or less than the predefined threshold; and
allocating to the selected request an initialization environment to initiate a further task; and
adding the further task into the task queue in response to the further task being initiated.

14. The system of claim 13, wherein selecting the request from the request queue further comprises:
selecting the request from the request queue according to a priority of the request.

15. The system of claim 10, wherein determining the resource to be accessed by the task comprises:
tracking an implementation history of a task initiated by a historical request, a type of the historical request being identical to the type of the request; and
determining the resource from the implement history.

16. The system of claim 10, wherein determining the length of the task queue comprises:
obtaining from a resource manager managing the resource a message associated with a further task; and
extracting the length of the task queue from the message.

17. The system of claim 16, wherein the message is encoded with a length of a further task queue, the further task queue recording a task waiting for a further resource managed by the resource manager.

18. A computer program product being tangibly stored on a non-transient machine-readable medium and comprising machine-executable instructions, the instructions, when executed on an electronic device, causing the electronic device to:
determine a resource to be accessed by a task in a processing system based on a type of a request for initiating the task;
determine a length of a task queue that records at least one task waiting for the resource; and
suspend the request in response to the length of the task queue being greater than a predefined threshold.

19. The computer program product of claim 18, wherein the instructions further cause the electronic device to:
in response to the length of the task queue being equal to or less than the predefined threshold;
allocate to the request an initialization environment to initiate the task; and
add the task into the task queue in response to the task being initiated.

20. The computer program product of claim 18, wherein the instructions further causing the electronic device to:
track an implementation history of a task initiated by a historical request, a type of the historical request being identical to the type of the request; and
determine the at least one resource from the implement history.
